(19) United States
(12) Patent Application Publication
(10) Pub. No.: US 2015/0096536 A1
(43) Pub. Date: Apr. 9, 2015

(54) PULSE DAMPER USING COMPOSITE SPRING

(71) Applicant: Byoung-Chan Hwang, Seoul (KR)

(72) Inventor: Byoung-Chan Hwang, Seoul (KR)

(21) Appl. No.: 14/395,818

(22) PCT Filed: Apr. 12, 2013
(86) PCT No.: PCT/KR2013/003092

§ 371 Date: Oct. 21, 2014

(30) Foreign Application Priority Data
Apr. 27, 2012 (KR) 10-2012-0044326

(51) Int. Cl. F02M 55/04; F02M 63/02

(52) U.S. Cl. CPC F02M 55/04; F02M 63/0265
USPC 123/456; 123/457

(57) ABSTRACT

Disclosed is a pulse damper using a composite spring device for eliminating pulse waves in a plunger pump for supplying fuel, which includes a spring body, and a body for receiving an O-ring spacer supported by an internal O-ring cap, wherein a low pressure coil spring and a high pressure disc spring are arranged in a line inside the spring body so that the low pressure oil spring primarily works and then stops by making a low pressure spring cover and a low pressure spring pad contact a low pressure spring stopper, and secondarily the high pressure disc spring works and then stops by making a high pressure spring pad mounted on one end of a spring guide shaft connected to a piston contact a high pressure spring stopper.

### TECHNICAL FIELD

The present invention relates to a pulse damper used in a gasoline direct injection engine, and more particularly, to a pulse damper using a composite spring, in which a piston to be movable in a straight reciprocal way in a pulse damper body attached to a fuel rail of the gasoline direct injection engine repeatedly converts pulse waves in fuel into compression energy using the composite spring, stores and discharges the compression energy, thereby eliminating the pulse waves generated in a plunger pump for supplying fuel so as to maintain fuel pressure at a constant level in which no pulse waves are present in the fuel, and enabling the usage of the pump damper without engine pump loss.

### BACKGROUND ART

In general, an engine for a vehicle supplies fuel stored in a fuel tank to an injector at high pressure using a fuel pump. The injector is configured to inject the fuel that is forcibly supplied to the injector at the high pressure into a cylinder.

A gasoline engine for a vehicle may be classified into two types, i.e., multi-port injection (MPI) and gasoline direction injection (GDI) according to a fuel injection method.

Here, a gasoline direct injection engine is an engine having high efficiency in which fuel is fully combusted, by manufacturing fuel with high pressure and fine particles, directly injecting the fuel into an engine cylinder and then igniting the fuel using an ignition plug and exploding the fuel. In this way, the gasoline direct injection engine is an engine that may prevent air pollution by discharging a fully-combusted engine exhaust gas in the air.

A gasoline direct injection engine with the high pressure (250 bar or higher) has been recently developed.

The gasoline direct injection engine includes a plunger pump (separate element) that is a high pressure generator and a fuel injector (separate element), a connection tube (separate element), and a fuel rail (separate element).

The above-described gasoline direct injection engine operates at low pressure of 10 bar so as to reduce fuel consumption and operates at pressure of 250 bar or higher so as to operate with a high output. In this way, the gasoline direct injection engine operates in a wide range of pressure in which a pressure variation width of the gasoline direct injection engine is 25 times that of a general engine for a vehicle, so that high pressure is generated by the plunger pump and simultaneously, pulse waves having large amplitude are generated.

In this way, when the pulse waves having large amplitude are directly propagated to an injector, a fuel injection amount varies instantaneously. Due to changes in the fuel injection amount, engine efficiency is reduced, and the gasoline direct injection engine vibrates, and noise occurs in the gasoline direct injection engine.

For the above reason, a wide range pulse damping device is required to attenuate the pulse waves in a wide range of pressure.

In the related art, the high-pressure pulse waves are attenuated by mounting an orifice on the fuel rail. However, in the conventional pulse damping device using the orifice, a cross-sectional area of a fuel line is rapidly reduced so that resistance occurs in a flow rate and a pressure and thus the pulse waves are attenuated. In the conventional pulse damping device using the orifice, the flow rate and the pressure resistance are used so that large pump energy loss occurs.

Also, Korean Patent Application No. 10-2007-0070249 that is the related art discloses a pulse damper using a single disc spring. However, the technology uses the single disc spring such that it is difficult to control pulsation in a wide range of pressure, like in the gasoline direct injection engine.

In all types of springs, plastic deformation occurs when deformation of a spring exceeds an elasticity limit. Thus, the spring loses a spring restoration force and spring performance. The pulse damper disclosed as the above patent technology has a structure in which no stopper for stopping an operation at a load that exceeds an elastic region, so as to prevent plastic deformation, is present. Thus, the pulse damper according to the related art is vulnerable to plastic deformation of the spring.

### DISCLOSURE

### Technical Problem

The present invention is directed to providing a pulse damper using a composite spring, in which pulse waves in fuel are repeatedly converted into compression energy, are repeatedly stored and discharged, thereby eliminating the pulse waves generated in a plunger pump for supplying fuel so as to maintain fuel pressure at a constant level in which no pulse waves are present in the fuel, and to cover a wide range of pressure and an airtight state and escape of each of components can be minimized so that the useful usage of the pump damper can be performed without energy loss.

### Technical Solution

One aspect of the present invention provides a pulse damper using a composite spring that may be applied in a wide range of pressure, the pulse damper being installed at a fuel rail for supplying engine fuel of a gasoline direct injection engine so as to reduce pulsation of a fluid, the pulse damper including: a spring body in which the composite spring is arranged and a spring guide shaft connected to a piston to be reciprocally movable in the spring body is installed; a body which is coupled to the spring body by a thread joint and in which an O-ring spacer between a pair of sealing inner O-rings is mounted on an outer ring of the piston to be supported by an O-ring stopper; and a connection connector and a connection path that are inserted into one side of the body and are bonded to a fuel rail pipe.

### Advantageous Effects

As described above, according to the present invention, pulse waves can be offset in proportion to the size of the pulse waves that are propagated into a fuel rail pipe, and a fluid is dispersed so that a pulsation phenomenon of the discharged fluid can be minimized. Thus, an operation of a working portion that works by supply of the fluid can be made uniform, and noise caused by pulsation can be reduced so that operation characteristics can be improved, and no energy loss occurs so that a fuel cost can be reduced.

### DESCRIPTION OF DRAWINGS

FIG. 1 is a longitudinal cross-sectional view of a pulse damper according to an exemplary embodiment of the present invention.

FIG. 2 is a longitudinal cross-sectional view of a pulse damper according to another exemplary embodiment of the present invention.

FIG. 3 is a graph showing a low elastic modulus spring motion curve according to the present invention.

FIG. 4 is a graph showing a high elastic modulus spring motion curve according to the present invention.

FIG. 5 is a graph showing a high and low elastic modulus composite spring motion curve according to the present invention.

FIG. 6 is a longitudinal cross-sectional view of a pulse damper according to still another exemplary embodiment of the present invention.

FIG. 7 is a longitudinal cross-sectional view of a pulse damper according to yet still another exemplary embodiment of the present invention.

### MODES OF THE INVENTION

Hereinafter, exemplary embodiments of the present invention will be described in detail with reference to the attached drawings.

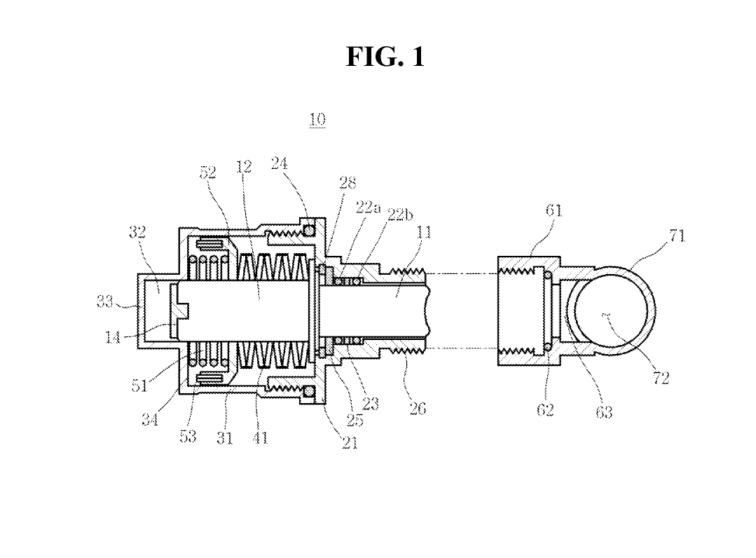

FIG. 1 is a longitudinal cross-sectional view of a pulse damper according to an exemplary embodiment of the present invention.

As illustrated in FIG. 1, a pulse damper 10 using a composite spring according to an exemplary embodiment of the present invention includes a body 21 in which a piston 11 to be movable in a straight reciprocal way is installed, a spring body 31 that is coupled to the body 21 by a thread joint, and a connection connector 61 that is coupled to the body 21 by the thread joint.

The connection connector 61 is formed integrally with a fuel rail pipe 71 connected to a plunger pump (not shown) for supplying fuel of a gasoline direct injection engine, and a connection path 63 is formed in the connection connector 61. The piston 11 that is formed integrally with a spring guide shaft 12 is installed in the body 21 coupled to the connection connector 61 by the thread joint.

The spring guide shaft 12 is disposed in the spring body 31 such that a low pressure coil spring 51 and a high pressure disc spring 41 are arranged in a line to be reciprocally movable.

A low pressure spring cover 52 that protects an elastic limit force of the low pressure coil spring 51 is mounted between the low pressure coil spring 51 and the high pressure disc spring 41 that are mounted on the spring guide shaft 12 in a line.

Also, a high pressure spring pad 14 for protecting an elastic limit force of the high pressure disc spring 41 is mounted on one end of the spring guide shaft 12.

Top and bottom ends of the low pressure spring cover 52 are bent at right angles, and a low pressure spring pad 53 for protecting an elastic limit force is mounted on a distal end of a horizontal bending portion and protrudes toward a low pressure spring stopper 34 that is formed as one sidewall surface of the spring body 31.

The low pressure coil spring 51 having a low elastic modulus and the high pressure disc spring 41 having a high elastic modulus are arranged in a line inside the spring body 31 so that the low pressure coil spring 51 primarily works and then stops by making a low pressure spring cover 52 and a low pressure spring pad 53 contact a low pressure spring stopper 34 so as to protect an elastic limit force of the low pressure coil spring 51.

Next, the high pressure disc spring 41 secondarily works.

Here, the high pressure disc spring 41 stops by making the high pressure spring pad 14 mounted on one end of the spring guide shaft 12 connected to the piston 11 contact inner walls of a stopper 33 that protrudes from one side of the spring body 31 so as to protect the elastic limit force of the high pressure disc spring 41.

A piston motion space portion 32 is formed in the stopper 33 so that a reciprocal motion of the piston guide shaft 12 can be made by motions of the high pressure and low pressure springs 41 and 51.

An O-ring spacer 23 between a pair of sealing inner O-rings 22a and 22b is mounted in the body 21 coupled to the spring body 31 by the thread joint in such a way that the O-ring spacer 23 may be mounted on an outer ring of the piston 11 and may be mounted to be supported by an O-ring stopper 25 and a stop ring 28.

The high pressure spring pad 14 is mounted on a rear end of the piston guide shaft 12 and serves as a secondary cushion spring.

Also, an outer O-ring 24 is mounted in a region that is bonded to an outer edge of one side of the body 21. A thread 26 that is coupled to the connection connector 61 by the thread joint that is bonded to the fuel rail pipe 71 that retains a rail pipe internal chamber 72, is disposed at the other side of the body 21, and a connector O-ring 62 is mounted in an inner chamber of the connection connector 61.

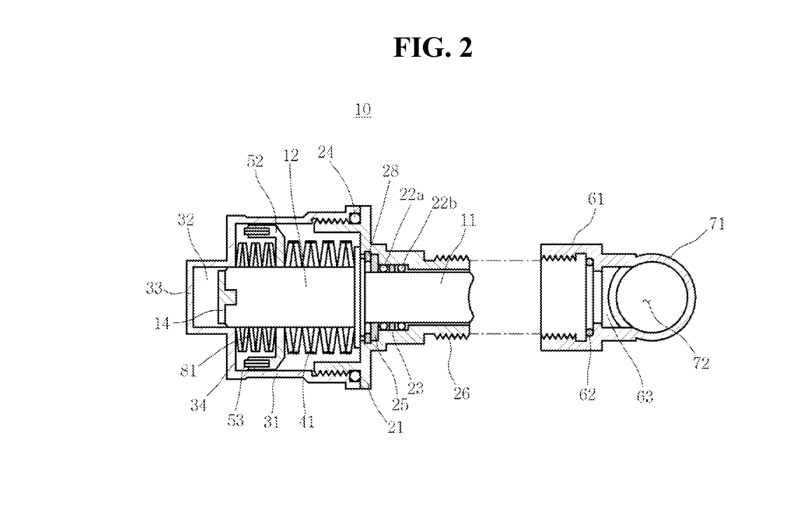

FIG. 2 is a cross-sectional view of main elements of a pulse damper according to another exemplary embodiment of the present invention. As illustrated in FIG. 2, a low pressure disc spring 81 is mounted in a spring body instead of the low pressure coil spring 51 of FIG. 1.

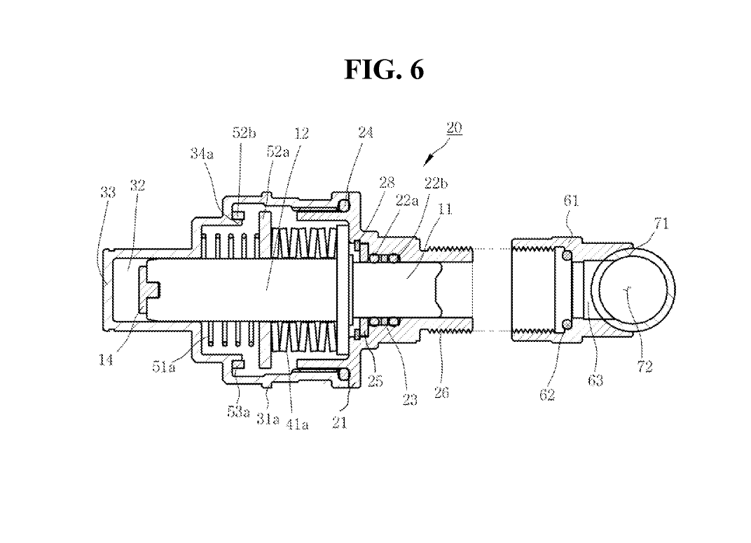

FIG. 6 is a longitudinal cross-sectional view of a pulse damper according to still another exemplary embodiment of the present invention.

As illustrated in FIG. 6, a pulse damper 20 using a composite spring according to still another exemplary embodiment of the present invention includes a body 21 in which a piston 11 to be movable in a straight reciprocal way, a spring body 31a that is coupled to the body 21 by a thread joint, and a connection connector 61 that is coupled to the body 21 by the thread joint.

The connection connector 61 is formed integrally with a fuel rail pipe 71 connected to a plunger pump (not shown) for supplying fuel of a gasoline direct injection engine, and a connection path 63 is formed in the connection connector 61. A piston 11 is installed in the body 21 coupled to the connection connector 61 by the thread joint and is formed integrally with the spring guide shaft 12.

A spring guide shaft 12 is disposed on the spring body 31a in which a low pressure coil spring 51a and a high pressure disc spring 41a are arranged in a line to be reciprocally movable.

A low pressure spring cover 52a that protects an elastic limit force of the low pressure coil spring 51a is mounted between the low pressure coil spring 51a and the high pressure disc spring 41a that are mounted on the spring guide shaft 12 in a line.

Also, a high pressure spring pad 14 for protecting an elastic limit force of the high pressure disc spring 41a is mounted on one end of the spring guide shaft 12.

The low pressure spring cover 52a is formed as a plane in which the low pressure spring cover 52a is stood in a vertical direction. A support portion 52b is formed at an inner side surface of a stop position of one side of the spring body 31a, and a low pressure spring pad 53a for protecting an elastic limit force is fixed to the spring body 31a so as to correspond to the low pressure spring cover 52a.

The low pressure coil spring 51a having a low elastic modulus and the high pressure disc spring 41a having a high elastic modulus are arranged in a line inside the spring body 31 a so that the low pressure coil spring 51a primarily works and then stops by making a low pressure spring cover 52a contact a low pressure spring pad 53a so as to protect an elastic limit force of the low pressure coil spring 51a.

Next, the high pressure disc spring 41a secondarily works.

Here, the high pressure disc spring 41a stops by making the high pressure spring pad 14 mounted on one end of the spring guide shaft 12 connected to the piston 11 contact inner walls of a stopper 33 that protrudes from one side of the spring body 31a so as to protect the elastic limit force of the high pressure disc spring 41a.

A piston motion space portion 32 is formed in the stopper 33 so that a reciprocal motion of the piston guide shaft 12 can be made by motions of the high pressure and low pressure springs 41a and 51a.

An O-ring spacer 23 between a pair of sealing inner O-rings 22a and 22b is mounted in the body 21 coupled to the spring body 31a by the thread joint in such a way that the O-ring spacer 23 may be mounted on an outer ring of the piston 11 and may be mounted to be supported by an O-ring stopper 25 and a stop ring 28.

The high pressure spring pad 14 is mounted on a rear end of the piston guide shaft 12 and serves as a secondary cushion spring.

Also, an outer O-ring 24 is mounted in a region that is bonded to an outer edge of one side of the body 21. A thread 26 that is coupled to the connection connector 61 by the thread joint that is bonded to the fuel rail pipe 71 that retains a rail pipe internal chamber 72, is disposed at the other side of the body 21, and a connector O-ring 62 is mounted in an inner chamber of the connection connector 61.

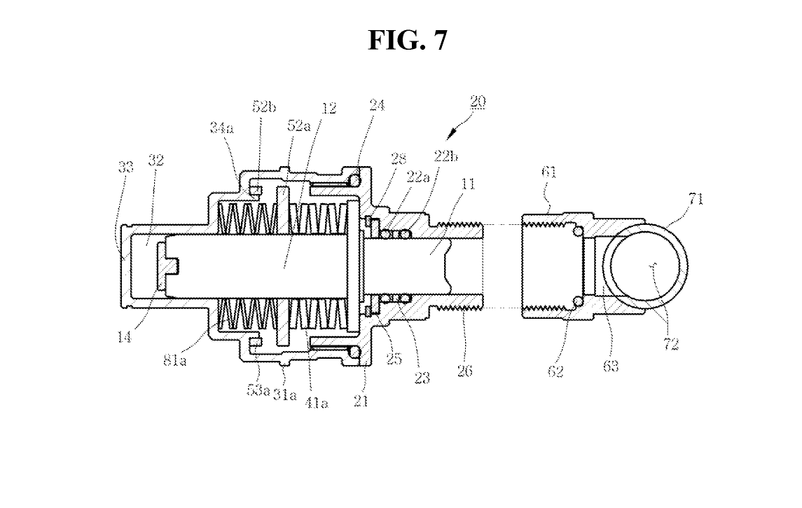

FIG. 7 is a cross-sectional view of main elements of a pulse damper according to still another exemplary embodiment of the present invention. As illustrated in FIG. 7, a low pressure disc spring 81a is mounted in a spring body instead of the low pressure coil spring 51a of FIG. 6.

In the pulse dampers 10 and 20 having the above configuration, the low pressure coil springs 51 and 51a and the high pressure disc springs 41 and 41a are mounted on the spring bodies 31 and 31a, and the spring bodies 31 and 31a and the body 21 are coupled by a thread joint, and the spring guide shaft 12 that makes a reciprocal motion, like in the low pressure coil springs 51 and 51a and the high pressure disc springs 41 and 41a, is mounted in the spring bodies 31 and 31a, and the piston 11 that is formed integrally with the spring guide shaft 12 is mounted so as to make a reciprocal motion in the body 21, as illustrated in FIGS. 1 and 6.

Thus, high pressure pulse waves generated when the plunger pump for supplying engine fuel of the gasoline direct injection engine is in a compression process, are propagated into the piston 11 through the fuel path 63 via the rail pipe inner chamber 72.

The pulse waves propagated into the piston 11 cause the piston 11 to work and cause the spring guide shaft 12 that is formed integrally with the piston 11 to work so that the pulse waves are propagated into the high pressure disc springs 41 and 41a and the low pressure coil springs 51 and 51a, the high pressure disc springs 41 and 41a and the low pressure coil springs 51 and 51a are contracted and the pulse waves are converted into compression energy and stored in either one of the high pressure disc springs 41 and 41a and the low pressure coil springs 51 and 51a or both the high pressure disc springs 41 and 41a and the low pressure coil springs 51 and 51a.

Also, the compression energy that is the pulse waves stored in either one of the high pressure disc springs 41 and 41a and the low pressure coil springs 51 and 51a or both the high pressure disc springs 41 and 41a and the low pressure coil springs 51 and 51a causes compression energy that has been stored in the high pressure disc springs 41 and 41a or the low pressure coil springs 51 and 51a when the high pressure disc springs 41 and 41a or the low pressure coil springs 51 and 51a expand in a state in which the plunger pump for supplying engine fuel is in a suction motion, to be discharged again into the fuel at high pressure.

In this way, the high pressure disc springs 41 and 41a or the low pressure coil springs 51 and 51a repeatedly convert the pulse waves in the fuel into compression energy, repeatedly store and discharge the compression energy, thereby eliminating the pulse waves generated in the plunger pump for supplying the fuel so as to maintain fuel pressure at a constant level in which no pulse waves are present in the fuel, so that a pulse damper without energy loss can be implemented.

In the present invention, the sealing inner O-rings 22a and 22b are inserted into the body 21 so that an airtight state can be maintained, and an inner O-ring spacer 23 for maintaining a distance between the O-rings 22a and 22b is mounted, and an inner O-ring stopper 25 is mounted so as to prevent escape of the sealing inner O-rings 22a and 22b.

Also, in order to prevent an overload from being applied to the high pressure disc springs 41 and 41a, the high pressure spring pad 14 for a secondary cushion is mounted on one side of the spring guide shaft 12.

Also, as illustrated in FIG. 1, in order to prevent an overload from being applied to the low pressure coil spring 51, the low pressure spring pad 53 for a secondary cushion is mounted to protrude toward upper and lower bended portions of the low pressure spring cover 52 mounted between the high pressure disc spring 41 and the low pressure coil spring 51.

Also, as illustrated in FIG. 6, in order to prevent an overload from being applied to the low pressure coil spring 51a, the low pressure spring pad 53a for a secondary cushion is mounted on the support portion 52b formed at an inner side surface of a step portion of one side of the spring body 31a so as to correspond to the low pressure spring cover 52a mounted between the high pressure disc spring 41a and the low pressure coil spring 51a, so that an elastic limit force can be protected.

Also, an outer O-ring 24 is mounted to prevent secondary oil leakage of the fuel.

In the present invention, the body 21 and the connection connector 61 are fastened to each other using a joint thread, and the connection connector 61 is attached to the fuel rail pipe 71 so that the pulse damper 10 can be stably attached to the fuel rail pipe 71 so as to work well.

Thus, according to the present invention, the pulse damper 10 without energy loss can be obtained.

In the present invention, as illustrated in FIGS. 2 and 7, the low pressure coil springs 51 and 51a are replaced with the low pressure disc springs 81 and 81a so that, after the pulse waves are converted into compression energy and stored, the compression energy that has been stored in the high pressure disc springs 41 and 41a or the low pressure coil springs 51 and 51a when the high pressure disc springs 41 and 41a or the low pressure disc springs 81 and 81a expand, is discharged again to the fuel at high pressure.

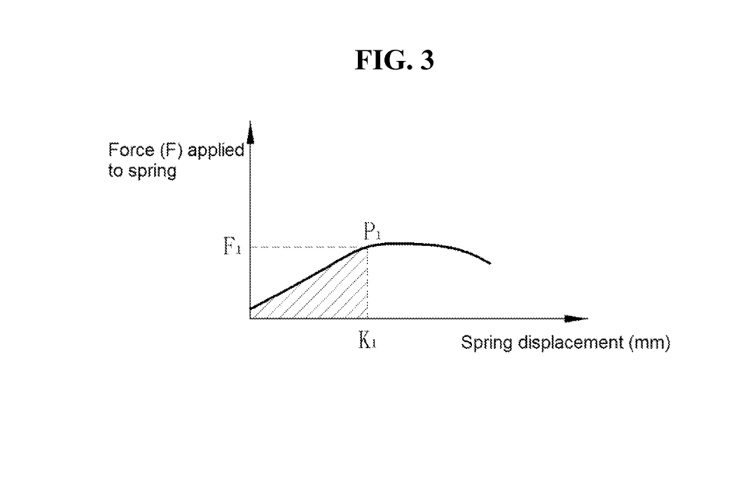

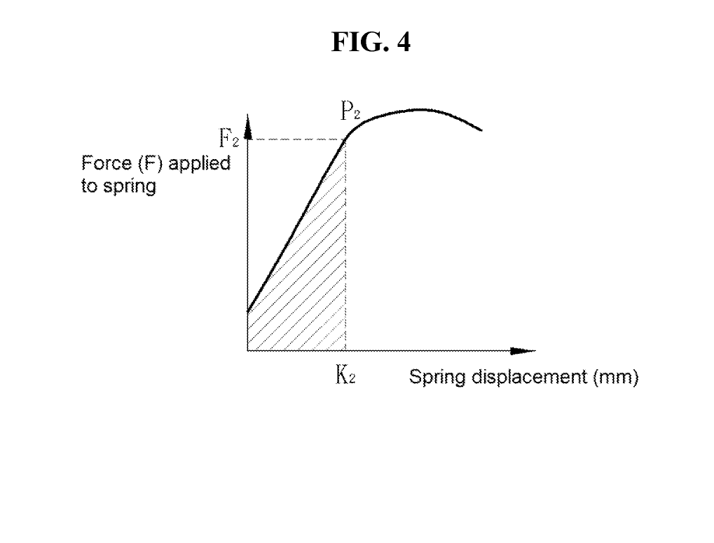

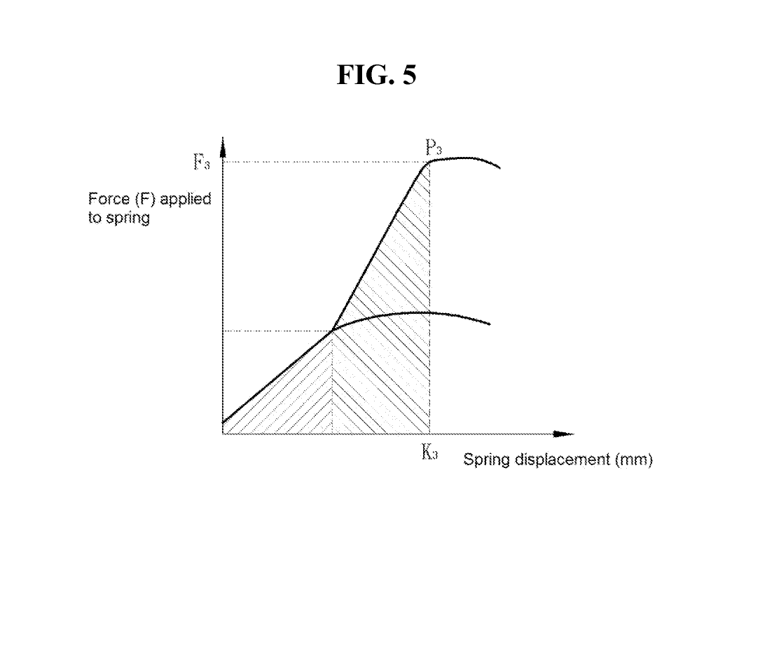

Thus, as illustrated in FIG. 3, a low pressure spring stop position P1 in which a force F1 applied to a low elastic modulus spring exerts in proportion to low elastic spring displacement K1, may be identified, and as illustrated in FIG. 4, a high pressure spring stop position P2 in which a force F2 applied to a high elastic modulus spring exerts according to high elastic modulus spring displacement K2, may be identified, and as illustrated in FIG. 5, a composite spring stop position P3 in which a force F3 applied to the composite spring exerts according to composite spring displacement K3, may be identified.

### INDUSTRIAL APPLICABILITY

According to the present invention, pulse waves in fuel are repeatedly converted into compression energy and are repeatedly stored and discharged so that the pulse waves generated in the plunger pump for supplying the fuel are eliminated so as to maintain fuel pressure at a constant level in which no pulse waves are present in the fuel, so that a pulse damper without energy loss can be implemented. Thus, an operation of a working portion that works by supply of a fluid can be made uniform, and noise caused by pulsation can be reduced so that operation characteristics can be improved, and no energy loss occurs so that a fuel cost can be reduced and thus the present invention has a very large industrial applicability.

While the invention has been shown and described with reference to certain exemplary embodiments thereof, it will be understood by those skilled in the art that various changes in form and details may be made therein without departing from the spirit and scope of the invention as defined by the appended claims.

1. A pulse damper (10) using a composite spring, in which a connection connector (61) is formed at a fuel rail pipe (71) connected to a pump for supplying fuel of a gasoline direct injection engine so as to dispose an connection path (63) inside the connection connector (61) and a body (21) coupled to the connection connector (61) in a thread is coupled to a spring body (31) having a buffer unit disposed therein, and which reduces pulsation of the fuel, the pulse damper (10) comprising:
a low pressure coil spring (51) and a high pressure disc spring (41) that are arranged together with a spring guide shaft (12) disposed to be reciprocally movable inside the spring body (31);
a low pressure spring cover (52) in which the low pressure coil spring (51) and the high pressure disc spring (41) are mounted in a line and which is disposed between the low pressure coil spring (51) and the high pressure disc spring (41) so as to protect an elastic limit force of the low pressure coil spring (51); and
a high pressure spring pad (14) in which the spring guide shaft (12) and the piston (11) are formed integrally with each other and which is mounted on one end of the spring guide shaft (12) so as to protect an elastic limit force of the high pressure disc spring (41).

2. The pulse damper of claim 1, wherein the low pressure coil spring (51) having a low elastic modulus and the high pressure disc spring (41) having a high elastic modulus are mounted in a line inside the spring body (31) so that the low pressure coil spring (51) primarily works and stops by making the low pressure spring cover (52) and the low pressure spring pad (53) contact a low pressure spring stopper (34) so as to protect an elastic force of the low pressure coil spring (51).

3. The pulse damper of claim 1, wherein the low pressure coil spring (51) having a low elastic modulus and the high pressure disc spring (41) having a high elastic modulus are mounted in a line inside the spring body (31) so that the low pressure coil spring (51) primarily works and the high pressure disc spring (41) secondarily works and stops by making the high pressure spring pad (14) mounted on one end of the spring guide shaft (12) connected to the piston (11) contact the high pressure spring stopper (33) so as to protect an elastic limit force of the high pressure disc spring (41).

4. The pulse damper of claim 1, wherein the body (21) is coupled to the spring body (31) by a thread joint, and an O-ring spacer (23) is mounted between a pair of sealing inner O-rings (22a) and (22b) in such a way that the O-ring spacer (23) is mounted on an outer ring of the piston (11) and is supported by an inner O-ring stopper (25).

5. The pulse damper of claim 1, wherein the pulse damper has a structure in which the low pressure disc spring (81) is mounted instead of the low pressure coil spring (51).

6. A pulse damper (20) using a composite spring, in which a connection connector (61) is formed at a fuel rail pipe (71) connected to a pump for supplying fuel of a gasoline direct injection engine so as to dispose an connection path (63) inside the connection connector (61) and a body (21) coupled to the connection connector (61) in a thread is coupled to a spring body (31a) having a buffer unit disposed therein, which reduces pulsation of the fuel, the pulse damper (20) comprising:
a low pressure coil spring (51a) and a high pressure disc spring (41a) that are arranged together with a spring guide shaft (12) disposed to be reciprocally movable inside the spring body (31a);
a low pressure spring cover (52a) in which the low pressure coil spring (51a) and the high pressure disc spring (41a) are mounted in a line and which is disposed between the low pressure coil spring (51a) and the high pressure disc spring (41a) so as to protect an elastic limit force of the low pressure coil spring (51a); and
a high pressure spring pad (14) in which the spring guide shaft (12) and the piston (11) are formed integrally with each other and which is mounted on one end of the spring guide shaft (12) so as to protect an elastic limit force of the high pressure disc spring (41a).

7. The pulse damper of claim 6, wherein a step portion is formed at one side of the spring body (31a), and a support (52b) is formed at an inner side surface of the step portion, and a low pressure spring pad (53a) for protecting an elastic limit force is fixed to the spring body (31a) so as to correspond to the low pressure spring cover (52a).

8. The pulse damper of claim 6, wherein the pulse damper has a structure in which a low pressure disc spring (81a) is mounted instead of the low pressure coil spring (51a).
